(19) United States
(12) Patent Application Publication
(10) Pub. No.: US 2008/0213717 A1
(43) Pub. Date: Sep. 4, 2008

(54) METHOD OF INCREASING THE EFFICIENCY OF MELTING METAL

(75) Inventors: P. Doug Shull, Grove City, OH (US); Hendrik Rumemper, London, OH (US); David Smith, Columbus, OH (US); Jeffrey Rademan, London, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: TRANSMET CORPORATION, Columbus, OH (US)

(21) Appl. No.: 12/033,555

(22) Filed: Feb. 19, 2008

Related U.S. Application Data
(60) Provisional application No. 60/932,984, filed on Mar. 1, 2007.

(51) Int. Cl. F27B 14/00; B32B 15/20

(52) U.S. Cl. 432/13; 428/650; 427/372.2

(57) ABSTRACT

A process for increasing the thermal radiation absorbance of objects that are to be melted or softened. An agent is applied to the object, such as an aluminum sow, and the object is placed in a furnace. The furnace exposes the object to thermal radiation, such as by blasting the sow with jets of burning gas, and the material melts. The increase in absorbance on the outer surface of the object reduces the amount of energy needed to melt or soften the material, as thermal energy is absorbed by the object more rapidly than uncoated materials.

### (e) BACKGROUND OF THE INVENTION

1. Field Of The Invention

This invention relates generally to processes for melting metal.

2. Description Of The Related Art

Thermal radiation is partially responsible for heat exchange between objects. Energy is gained by one object absorbing the thermal energy of surrounding objects that are warmer. Absorption is the process by which the energy of a photon is taken up by another entity. The term “absorption” refers to the physical process of an object absorbing light, whereas “absorbance” refers to the quantity of light that is absorbed by the object. An object appears white if it reflects all colors of visible light, and appears black if it absorbs all colors of visible light. Thus, it is generally understood that a darker color absorbs more visible light than a lighter color. The same is generally true of invisible light, although other characteristics of the material, such as surface texture, can affect absorbance.

Industrial metal is sold in large blocks or bodies called ingots, which have been melted and cast into a shape and size that is efficiently handled. In the aluminum industry, the larger of these ingots are commonly called “sows”, and a common sow size is approximately three feet wide by four feet long by one foot tall. Such sows weigh approximately 1,200 lbs. The sows are transported by their manufacturer to their final destination, at which the metal is melted in a furnace in order to be used in a casting or other metal-forming process.

A common furnace for melting aluminum sows uses natural gas flames to melt each sow. The temperature of the chamber in which the sow is heated is raised to over 1,900° F. to liquefy the metal by heating it using thermal radiation. The melting temperature of common pure aluminum is about 1,220° F. A substantial amount of energy is consumed in melting aluminum sows and other metal ingots, and it would be beneficial to reduce the energy required to melt metal.

### (f) BRIEF SUMMARY OF THE INVENTION

The invention includes a method of melting a body, such as a metal body, in a furnace. The method comprises applying to at least a portion of the outer surface of the body an agent that darkens that portion of the outer surface. The agent can be a paint or another coating agent, it can be carbon particles adhered to the surface or otherwise applied thereto or it can be another pigment, either organic or inorganic. The body is next placed in the furnace, and then exposed to thermal radiation. At least the darkened portion is exposed to the radiation for the purpose of melting at least part of the body. The melting can be followed by use of the molten metal in casting, such as rapid solidification casting, or any other manufacturing process.

The invention also contemplates a body, such as a metal ingot or aluminum sow, having at least a portion of the outer surface coated with a darkening agent. The body is configured for placing in a furnace that exposes the body to thermal radiation until the body melts. Preferably, a majority of the outer surface is coated with the darkening agent, such as carbon particles.

By darkening the outer surface of the body prior to exposure to thermal radiation, the absorbance of the body is dramatically increased, thereby reducing the amount of energy needed to melt the body. Use of the method has substantially reduced the amount of time necessary to melt aluminum sows, reduced the energy consumed per unit of aluminum melted, and reduced the amount of dross resulting from the melt.

### (g) BRIEF DESCRIPTION OF THE SEVERAL VIEWS OF THE DRAWINGS

FIG. 1 is a view in perspective illustrating a preferred metal ingot after being darkened to increase absorbance.

FIG. 2 is a schematic side view of a furnace containing a metal ingot that is being heated for melting.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

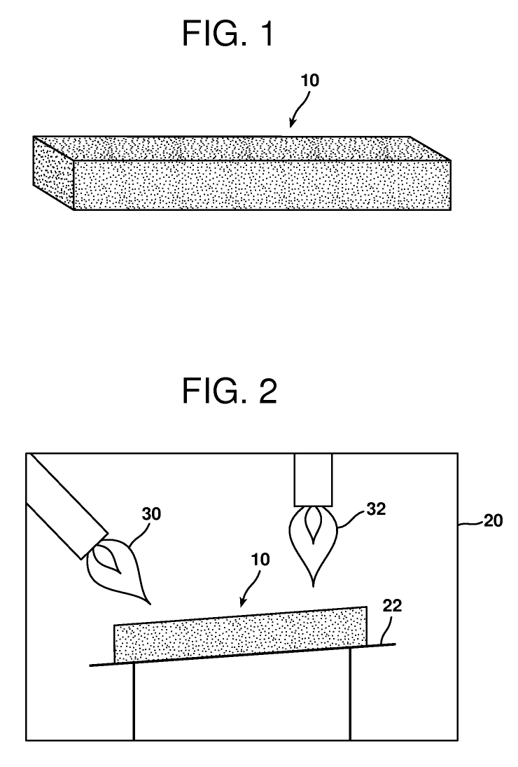

In a preferred embodiment of the invention, a darkening agent is applied to the outer surface of the aluminum sow 10 shown in FIG. 1. This agent is applied prior to heating the sow 10 in the furnace 20, shown in FIG. 2. The agent can be applied to the sow 10 by spraying, brushing, dipping, electrostatic deposition or any other suitable procedure that coats at least a portion of the outer surface of the sow 10 with the darkening agent. In a particularly preferred embodiment, the agent applied to the sow 10 is an inert graphite powder in 2,200° F. compatible air-dryable liquid that can contain mineral spirits and silica additives. The agent thus creates a coating that can be applied immediately before placing the sow 10 in the furnace 20, or the agent can be applied a substantial amount of time prior to heating.

Of course, the agent can be applied to the outer surface by other processes, including anodization, chemical etching, adhesive or any other means to form a darkened exterior surface on the body. Furthermore, vapor deposition and other coating processes can be used. Still further, the outer surface can be darkened by a material that is applied to the outer surface of the body when it is molten, such as by coating a vessel that the molten material is poured into to form a sow. Of course, the person of ordinary skill will recognize that such processes are relatively expensive to carry out, and are therefore less desirable unless a cost-justified increase in darkening over the preferred embodiment is realized.

As used herein, the term “darken” is defined to mean a change in color and/or other material property that causes a substantial, measurable increase in the absorbance of thermal energy via radiation and/or a decrease in the amount of thermal energy that is reflected from the surface of the object. The term “darken”, which is commonly considered to mean a color that is seen by the human eye, can, but is not necessarily considered to darken a body according to the invention. For example, it is possible for a material that appears to be darker, as that term is commonly used, than a metal to increase a metal body's reflectivity. Such a material would only darken a body, according to the invention, if the body's absorbance increases by the application of the material to the outer surface of the body. Such a material by darkening the body substantially before exposing it to thermal radiation, the amount of thermal energy needed to melt the body is reduced due to greater absorbance of the radiation.

The term “body” includes an object that is designed to be heated until it melts or softens. Thus, a body includes an ingot, a sow, a slab, a sheet, or any other such structure intended to be heated in order to melt or soften the material. The body's material as discussed herein is a metal, but can be a glass, plastic or other material subject to melting. Furthermore, the metal discussed herein is aluminum, but reference to metal is intended to include other metals in their pure forms, such as iron, copper, zinc and others, as well as alloys of metals, including steel, brass, and others. The number of metals that can be used with the present invention is too numerous to list, but will be understood by the person of ordinary skill from the disclosure herein.

It is preferred that only a portion of the outer surface of the sow 10 be darkened in order to reduce the labor necessary to carry out the invention, and to reduce material costs. For example, it is contemplated to darken only the top and sides of the sow 10, as shown, and not apply a darkening agent to the bottom. This is because the sow 10 is placed in the furnace 20 on a surface 22 that supports the sow 10 from beneath. In such an instance, the bottom of the sow 10 is not exposed to the thermal radiation to the same extent as the remainder of the outer surface. Thus, such a coating would be wasted, or at least of little value. In an alternative embodiment, only a portion of the top and sides is painted, such as by passing under a spraying nozzle, and a substantial portion of the sides, and possibly sections of the ends and top remain uncoated due to lack of spray coverage. Nonetheless, the sow 10 has a measurable increase in absorbance due to even a partial darkening.

After the outer surface of the sow 10 is darkened, the sow 10 is placed in the conventional furnace 20 and heated by exposing the sow 10 to jets of burning gas 30 and 32, as shown in FIG. 2. The jets of burning gas 30 and 32 transmit thermal energy to the sow by at least radiation in order to raise the temperature of the sow 10 until the melting point of aluminum is reached. Of course, any other furnaces that heat using at least radiation can be used instead of the furnace 20, including oil, gas or electric furnaces. By darkening the sow 10 prior to heating, the sow 10 absorbs thermal energy more rapidly than an otherwise similar body that is not darkened. This reduces the amount of energy needed to melt the sow 10 over the less absorptive body.

If desirable, it is possible that the material that darkens the sow 10 can become incorporated into the material of the sow during melting, although this is not required. If it is desired, then the darkening material can be selected to encourage such incorporation. Alternatively, it is possible to use a material that is not reactive with the material of the body, and merely becomes part of the dross that is removed in a conventional manner.

Experiments were performed to determine the effect of darkening at least some portion of the sow that is exposed to flames of a natural gas furnace. Those exposed portions were coated with dark carbon, and the sow was placed in a conventional furnace. The results of the tests showed a reduction in time needed to heat the sow until melting occurred, and a reduction in the temperature the furnace had to attain to melt the sow. For example, the entire time of melting the sow was reduced to about 1.25 hours from about 2 hours, and the sow melting zone (the area of the furnace in which the sow is melted) heated to only about 1,800° F. before significant melting took place, as compared to about 1,900 to about 2,250° F. for a conventional, non-darkened sow. This significant reduction in energy costs was realized from an increase in labor of only about five minutes required to brush or spray the sow with the coating material. This process also reduced the dross loss by a measurable amount, thereby reducing waste.

It will become apparent that the coating applied to the body, such as the sow 10, must withstand the temperature of the furnace heating the body to the melting point. Thus, coatings that burn away or react with the air, combustion products or the ingot surface at elevated temperatures will not suffice for the invention if the reacted coating has little to none of the darkening effect necessary for a measurable reduction in energy. However, coatings that darken as they react, which are contemplated by the invention, can be used to vary the process over coatings that begin dark and remain the same. Thus, although the invention is described herein as applying a darkening coating, the invention includes a coating that has little to no darkening effect initially, but darkens as the temperature rises, or as it reacts with the material of the body or its surroundings.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of melting a body in a furnace, the method comprising:
(a) applying to at least a portion of the outer surface of the body an agent that darkens said portion of the outer surface;
(b) placing the body in the furnace; and then
(c) exposing at least said portion of the body to thermal radiation to heat the body sufficiently to melt at least some of the body.

2. The method in accordance with claim 1, wherein the step of applying further comprises coating a majority of the outer surface of the body with a darkening agent.

3. The method in accordance with claim 2, further comprising orienting the body in the furnace with the darkened portion facing a radiant energy-producing portion of the furnace.

4. The method in accordance with claim 3, wherein the coating is a paint.

5. The method in accordance with claim 3, wherein the coating contains carbon particles.

6. The method in accordance with claim 3, wherein the coating is black.

7. The method in accordance with claim 3, wherein the body is an aluminum sow.

8. The product made by the steps of claim 1.

9. A body having at least a portion of the outer surface coated with a darkening agent, wherein the body is configured for placing in a furnace that exposes the body to thermal radiation until the body melts.

10. A metal body having at least a majority of the outer surface coated with a darkening agent, said body being disposed in a furnace that heats the body to its melting point by exposing the body to at least thermal radiation.

11. The metal body in accordance with claim 10, wherein the metal is aluminum, the body is a sow and said darkening agent further comprises at least some carbon particles.

12. A method of melting a body in a furnace, the method comprising:
(a) applying to at least a portion of the outer surface of the body an agent;
(b) placing the body in the furnace;
(c) heating the body sufficiently to cause the agent to darken said portion of the outer surface; and then
(d) heating the body sufficiently to melt the body.

13. The method in accordance with claim 12, wherein the body is metal.
